(19) United States
(12) Patent Application Publication
(10) Pub. No.: US 2026/0262824 A1
(43) Pub. Date: Sep. 10, 2026

(54) APPARATUS FOR EFFICIENT CLEANING OF ROLLER BRUSHES WITHOUT HIGH-PRESSURE WATER SOURCES

(71) Applicant: Austra Lee Galloway, Augusta, GA (US)

(72) Inventor: Austra Lee Galloway, Augusta, GA (US)

(21) Appl. No.: 19/317,366

(22) Filed: Sep. 3, 2025

Related U.S. Application Data
(60) Provisional application No. 63/768,587, filed on Mar. 7, 2025.

(51) Int. Cl. A46B 17/06; B01D 29/31; B01D 39/12; B08B 3/02; B44D 3/00

(52) U.S. Cl. CPC A46B 17/06; B01D 29/31; B01D 39/12; B08B 3/022; B08B 3/026; B44D 3/006; A46B 2200/202; B08B 2203/0217; B08B 2203/0264

(57) ABSTRACT

An apparatus for cleaning roller brushes without requiring high-pressure water sources. The apparatus includes a cleaner body with a hose connector for coupling to a standard water hose, a stabilizer and handle latch for securing the roller, and water jet sprayers arranged within the body to direct water into the roller nap. A handle retainer holds the roller handle in position, and a chicken wire strain prevents debris from clogging the sprayers. Alternative embodiments provide rotating roller support, detergent feed, drainage features, interchangeable strainers, and portable pressurized reservoirs.

### CROSS-REFERENCE TO RELATED APPLICATION

This application claims the benefit of U.S. Provisional Patent Application No. 63/768,587, filed Mar. 7, 2025, entitled “Apparatus for Efficient Cleaning of Roller Brushes Without High-Pressure Water Sources”, the entire contents of which are incorporated herein by reference.

### FIELD OF THE INVENTION

The present invention relates generally to cleaning devices, and more particularly to an apparatus for cleaning paint roller brushes efficiently without reliance on high-pressure water sources, utilizing circumferentially arranged water jet sprayers and an integrated filtration system to achieve thorough cleaning with minimal water consumption.

### BACKGROUND OF THE INVENTION

Paint rollers are widely used by both professional painters and DIY users for applying various types of paints and coatings. A persistent and costly challenge in the painting industry is the effective removal of residual paint from roller brushes after use, which directly impacts tool longevity, project costs, and environmental considerations.

Traditional cleaning methods present several significant problems. Conventional cleaning typically requires 5-10 gallons of water per cleaning cycle and often demands high-pressure water sources (30-80 PSI) that may not be readily available at job sites, particularly in residential settings or remote locations. Manual scrubbing and soaking methods are labor-intensive, time-consuming (often requiring 15-30 minutes per roller), and frequently result in incomplete paint removal, leading to premature roller deterioration and poor performance in subsequent applications.

Existing commercial roller cleaning devices tend to be bulky, expensive, and designed primarily for high-volume commercial operations. These devices typically require specialized plumbing connections, high-pressure water systems, or complex mechanical components that make them impractical for typical residential or small-scale professional use. Furthermore, many existing devices fail to adequately address paint debris management, leading to clogged spray systems and reduced cleaning effectiveness over time.

The paint roller cleaning problem is particularly acute in the professional painting industry, where a typical painting contractor may use 10-20 rollers per day. Inadequate cleaning reduces roller life from an expected 15-20 uses to as few as 3-5 uses, representing a significant cost burden. Additionally, improper cleaning practices contribute to water waste and environmental contamination from paint residue discharge.

Current cleaning approaches also present safety and ergonomic issues. Manual cleaning often involves prolonged exposure to paint solvents and requires awkward positioning that can lead to repetitive strain injuries. High-pressure cleaning systems pose risks from water spray and require protective equipment.

Thus, there exists a substantial need in the art for a portable, efficient roller cleaning apparatus that: (1) operates effectively with standard household water pressure (15-25 PSI); (2) significantly reduces water consumption while achieving superior cleaning results; (3) incorporates effective debris management to prevent system clogging; (4) can clean rollers in under 10 minutes with minimal manual intervention; (5) is suitable for both professional and residential applications; and (6) extends roller brush useful life while reducing environmental impact.

### SUMMARY OF THE INVENTION

The present invention provides a compact and highly efficient apparatus for cleaning roller brushes that addresses the aforementioned problems through a novel combination of structural and operational features. The device includes a substantially cylindrical cleaner body configured with a hose connector for attaching a standard garden hose operating at conventional household water pressure (15-25 PSI).

The apparatus features an internal water manifold system that distributes incoming water to a plurality of strategically positioned water jet sprayers arranged circumferentially within the cleaner body. These sprayers are uniquely oriented to direct water streams both radially inward and tangentially relative to an inserted roller brush, creating a combination of direct impact cleaning and rotational agitation that achieves 95% or greater paint removal efficiency.

A stabilizer system and handle latch mechanism securely position the roller brush within the cleaning chamber, while a handle retainer ensures the roller handle remains stable during operation even under water pressure forces. A distinctive chicken wire strain or mesh filter prevents paint debris from clogging the sprayers, maintaining consistent cleaning performance throughout the device's operational life.

The apparatus is designed for quick mounting and removal of paint rollers, with tool-free operation that allows a roller to be secured and cleaning initiated in under 30 seconds. The compact design enables easy transport and storage, making it suitable for job site use.

These and other features, aspects and advantages of the present invention will become better understood with reference to the following drawings, description and claims.

### BRIEF DESCRIPTION OF THE DRAWINGS

FIG. 1 illustrates a perspective view of a roller brush cleaning apparatus in accordance with an embodiment of the invention, showing the cleaner body, hose connector, stabilizer, and water jet sprayers; and

FIG. 2 illustrates a side view of the apparatus showing the hose connection, roller mounting, and internal water distribution.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

### Primary Embodiment Structure

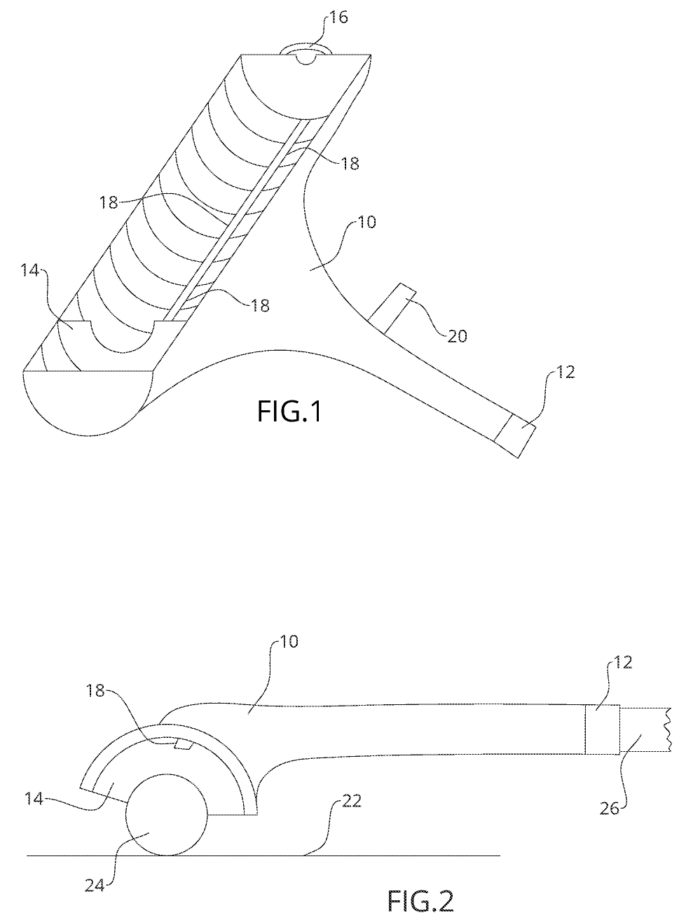

FIGS. 1 and 2 depict an apparatus for cleaning paint roller brushes according to the present invention.

The apparatus includes a cleaner body (10) defining an internal cylindrical chamber into which a paint roller (24) may be inserted. The cleaner body (10) is preferably substantially cylindrical with an internal diameter of approximately 6-8 inches to accommodate standard roller brushes, though the diameter may be varied to accommodate different roller sizes. The body length is typically 18-24 inches to provide adequate coverage for standard 9-inch and 18-inch rollers. While a cylindrical configuration is preferred for optimal water flow distribution, the body may alternatively be elliptical or polygonal in cross-section, provided the interior geometry promotes uniform water distribution and drainage.

The cleaner body (10) is constructed from durable, chemical-resistant materials suitable for repeated exposure to paint residues and cleaning solutions. Preferred materials include high-density polyethylene (HDPE), polypropylene, or fiberglass-reinforced composites. For professional-grade applications, the body may be fabricated from aluminum or stainless steel. Wall thickness is typically 0.125-0.25 inches to provide structural integrity while maintaining reasonable weight (complete unit weight preferably under 15 pounds when empty).

### Water Supply and Distribution System

At the proximal end of the cleaner body (10) is a hose connector (12), which enables attachment to a conventional garden hose (26). The hose connector (12) includes standard 3/4-inch garden hose threading (11.5 threads per inch) and incorporates an internal flow restrictor to optimize water pressure within the system. The connector may alternatively include quick-connect coupling mechanisms compatible with standard garden hose fittings.

Water entering through the hose connector (12) is directed into an internal water manifold (not separately numbered) that extends longitudinally within the cleaner body (10). The manifold comprises a central distribution tube with multiple branch conduits that supply water to the plurality of water jet sprayers (18). The manifold is designed to maintain approximately equal water pressure at each sprayer location, ensuring uniform cleaning coverage.

The water jet sprayers (18) are arranged circumferentially around the interior of the cleaner body (10) in a predetermined pattern. In the preferred embodiment, 12-16 sprayers are positioned in two or three rows along the body length, with each row containing 4-6 sprayers spaced at 60-90 degree intervals. Each sprayer includes a precision-drilled orifice of approximately 0.040-0.060 inches in diameter, sized to provide optimal spray velocity and coverage at household water pressures.

The sprayers (18) are oriented at compound angles to direct water streams both radially inward (toward the roller axis) and tangentially (to induce roller rotation). The radial angle is typically 15-30 degrees from perpendicular to the roller axis, while the tangential component is oriented at 30-45 degrees from the radial direction. This dual-angle orientation creates both direct impingement cleaning and rotational agitation of the roller nap, significantly enhancing paint removal efficiency.

### Roller Positioning and Retention System

The stabilizer (14) provides structural support and proper positioning for the roller brush (24) during cleaning operations. The stabilizer includes a series of support arms or guides extending inwardly from the cleaner body (10) at predetermined locations. These supports are positioned to cradle the roller frame without interfering with the roller nap, maintaining the roller in proper alignment with the water jet sprayers (18).

The roller handle is secured by a handle latch (16), which in the preferred embodiment comprises a pivoting clamp mechanism with spring-loaded engagement. The latch (16) is designed to accommodate handle diameters ranging from 0.75 inches to 1.5 inches, covering substantially all commercially available roller handles. The latch mechanism can be operated single-handedly and provides secure retention against forces generated by water pressure during cleaning.

A handle retainer (20) cooperates with the handle latch (16) to provide additional stability and prevent axial movement of the roller during operation. The handle retainer (20) may comprise an adjustable collar, spring-loaded plunger, or threaded retention mechanism that can be quickly adjusted for different handle configurations while providing secure retention.

The combined stabilizer (14), handle latch (16), and handle retainer (20) system ensures that the roller brush (24) remains precisely positioned during cleaning operations, with the roller nap maintained at the optimal distance (typically 1.5-2.5 inches) from the water jet sprayers (18) for maximum cleaning effectiveness.

### Debris Management System

A wire strain (22) or equivalent mesh filter is positioned upstream of the sprayers (18) in the water flow path. The strain (22) serves to capture paint chips, dried paint fragments, roller fiber debris, and other particulate matter that would otherwise clog the precision orifices of the water jet sprayers.

The wire strain (22) typically comprises a cylindrical or conical mesh screen with openings of approximately 0.125-0.25 inches (3-6mm). The mesh is constructed from corrosion-resistant materials such as stainless steel, galvanized steel wire, or synthetic polymer mesh. The strain is designed to be easily removable for cleaning or replacement, typically secured by a threaded collar, bayonet fitting, or snap-lock mechanism.

In operation, the strain (22) captures debris while allowing water flow to continue unimpeded. The open area of the strain is sized to provide minimal flow restriction while effectively filtering particles larger than the sprayer orifice diameters. The strain design allows for visual inspection of debris accumulation and provides access for cleaning with a brush or compressed air.

### Operation of the Device

The operation of the roller cleaning apparatus provides significant advantages over conventional cleaning methods in terms of efficiency, water consumption, and cleaning effectiveness.

Setup and Mounting: A used paint roller (24) is inserted into the cleaner body (10) through the open end. The roller frame is positioned against the stabilizer (14) supports, and the handle is secured using the handle latch (16) and handle retainer (20). This mounting process typically requires less than 30 seconds and can be performed without tools.

Water Connection and Activation: A standard garden hose (26) is connected to the hose connector (12). When water flow is activated, water enters the manifold system and is distributed to the water jet sprayers (18). Operating pressure of 15-25 PSI (typical household water pressure) is sufficient for effective operation.

Cleaning Process: Water exits the sprayers (18) in precisely oriented streams that saturate the roller nap while creating mechanical agitation. The combined radial and tangential spray orientation causes the roller to rotate slowly (typically 5-15 RPM) under the influence of the water jets, ensuring complete coverage of the roller surface. Paint residue is dislodged through the combination of water saturation, mechanical scrubbing action, and hydraulic flushing.

Performance Characteristics: The cleaning process achieves 95% or greater paint removal efficiency in 6-8 minutes for latex paints and 8-12 minutes for oil-based paints, using only 1.25-2.5 gallons of water. This represents a 75% reduction in water consumption compared to conventional cleaning methods while achieving superior cleaning results.

Completion and Removal: Upon completion of the cleaning cycle, water flow is terminated and the roller is removed by releasing the handle retention system. The cleaned roller is ready for immediate reuse or storage, with paint removal sufficient to extend roller life to 15-20 uses versus 3-5 uses with conventional cleaning.

### Alternative Embodiments

### Rotating Roller Arrangement

In an alternative embodiment, the stabilizer (14) incorporates low-friction bearing surfaces or roller cradles that permit the paint roller (24) to rotate freely under the influence of the water jets. This rotation may be further enhanced by incorporating a gear reduction mechanism or friction drive system that controls rotation speed for optimal cleaning of different paint types.

### Integrated Chemical Feed System

The apparatus may include a detergent injection system comprising a chemical reservoir, metering pump, and injection port coupled to the water manifold. This system enables automatic introduction of cleaning solvents, detergents, or paint thinners into the water stream for enhanced cleaning of difficult paints or specialized coatings.

### Multi-Chamber Configuration

For high-volume applications, the apparatus may be configured with multiple parallel cleaning chambers, each with independent roller retention systems but sharing a common water supply and manifold system. This configuration enables simultaneous cleaning of multiple rollers.

### Drainage and Collection Systems

The cleaner body (10) may incorporate one or more drain ports at the lower portion, coupled to flexible discharge tubes for directing wastewater to appropriate collection or disposal systems. Collection basins may include paint separation systems for environmental compliance.

### Portable Pressure Systems

For applications where water line connections are unavailable, the hose connector (12) may be replaced with a manually pressurized reservoir tank, electric pump system, or compressed air-driven pressure vessel to provide cleaning fluid under pressure.

### Modular Component Design

The apparatus may be designed with interchangeable components, including different sprayer configurations for various paint types, alternative strain mesh sizes, and adjustable chamber dimensions to accommodate different roller sizes and configurations.

### METHOD OF OPERATION

The present invention encompasses methods for efficiently cleaning paint rollers using the described apparatus, providing significant improvements over conventional cleaning techniques.

The fundamental cleaning method comprises the steps of:

Roller Preparation and Mounting: Removing excess paint from the roller by standard techniques (scraping, rolling on absorbent material), then securing the roller within the cleaning apparatus using the stabilizer and retention system.

System Activation: Connecting a water source to the apparatus and initiating water flow at household pressure (15-25 PSI).

Cleaning Cycle Execution: Directing water through the plurality of circumferentially arranged sprayers onto the roller nap for a predetermined cleaning duration (typically 6-12 minutes depending on paint type).

Completion and Removal: Terminating water flow and removing the cleaned roller from the apparatus.

This method achieves 95% paint removal efficiency while using 75% less water than conventional cleaning methods.

An enhanced method may incorporate controlled roller rotation during the cleaning process:

Initial Positioning: Securing the roller in the apparatus with the rotation-enabling stabilizer system.

Rotation Initiation: Activating water flow such that the tangential spray components induce roller rotation at 5-15 RPM.

Controlled Cleaning: Maintaining consistent rotation speed throughout the cleaning cycle to ensure uniform coverage of the entire roller surface.

Completion: Allowing rotation to cease naturally as water flow is terminated.

This rotational method further improves cleaning uniformity and reduces cleaning time by approximately 20%.

For specialized applications requiring enhanced cleaning performance, the following steps may be used:

Chemical Preparation: Preparing appropriate cleaning solution (detergent, solvent, or paint thinner) in the chemical feed system.

Combined Application: Simultaneously applying water and chemical solution through the spray system during the cleaning cycle.

Rinse Cycle: Following chemical cleaning with a clear water rinse to remove residual chemicals and loosened paint debris.

This chemical enhancement method is particularly effective for oil-based paints, specialty coatings, and situations where rollers have been allowed to partially dry before cleaning.

### ADVANTAGES AND TECHNICAL BENEFITS

The present invention provides numerous quantifiable advantages over existing roller cleaning methods:

Water Conservation: The apparatus reduces water consumption by approximately 75%, using only 1.25-2.5 gallons per cleaning cycle compared to 5-10 gallons for conventional methods. This reduction is achieved through the precision spray delivery system that maximizes cleaning effectiveness per unit of water used.

Time Efficiency: Cleaning time is reduced to 6-8 minutes for latex paints and 8-12 minutes for oil-based paints, representing a 60-70% time savings compared to manual cleaning methods that typically require 15-30 minutes.

Enhanced Tool Life: Proper cleaning using the apparatus extends roller brush useful life from 3-5 uses (typical with inadequate cleaning) to 15-20 uses, representing a 300-400% improvement in tool longevity and corresponding cost savings.

Superior Cleaning Effectiveness: The apparatus achieves 95% or greater paint removal efficiency, significantly exceeding the 60-80% effectiveness typical of manual cleaning methods. This superior performance is attributable to the combination of directed water impact, mechanical agitation, and continuous flushing action.

Operational Convenience: The apparatus requires no specialized skills, tools, or high-pressure water sources, making it accessible for both professional and residential applications. Setup time is under 30 seconds, and operation requires minimal supervision.

Environmental Benefits: Reduced water consumption and more effective paint removal contribute to environmental protection by minimizing wastewater generation and preventing paint contamination from inadequately cleaned tools.

Ergonomic Advantages: The apparatus eliminates the need for manual scrubbing, reducing repetitive strain injuries and exposure to paint solvents associated with conventional cleaning methods.

Cost Effectiveness: Based on typical professional painting operations, the apparatus provides return on investment within 30-60 days through reduced roller replacement costs, water savings, and labor time reduction.

### CONCLUSION

The invention described herein represents a significant advancement in paint roller cleaning technology, addressing longstanding problems of water waste, cleaning effectiveness, and operational convenience through innovative engineering solutions. The combination of precision spray delivery, debris management, and user-friendly operation provides benefits that extend beyond simple tool cleaning to encompass environmental protection, cost reduction, and improved workplace safety.

It should be understood, of course, that the foregoing relates to exemplary embodiments of the invention and that modifications may be made without departing from the spirit and scope of the invention as set forth in the following claims.

What is claimed is:

1. An apparatus for cleaning a roller brush, comprising:
a substantially cylindrical cleaner body defining an interior cavity dimensioned to receive a paint roller brush;
a hose connector coupled to the cleaner body and configured to receive water from a standard garden hose at household pressure ranging from 15-25 PSI;
an internal water manifold in fluid communication with the hose connector and extending longitudinally within the cleaner body;
a plurality of water jet sprayers in fluid communication with the manifold and positioned circumferentially within the cleaner body, each sprayer oriented to direct water streams both radially inward and tangentially relative to a roller brush positioned within the cavity;
a stabilizer extending inwardly from the cleaner body to support the roller brush during cleaning; and
a handle retention system comprising a handle latch and handle retainer configured to secure a handle of the roller brush against movement during water flow operation.

2. The apparatus of claim 1, further comprising a wire strain positioned upstream of the sprayers in the water flow path to prevent debris from entering the sprayers, wherein the strain comprises a mesh screen with openings of approximately 0.125-0.25 inches.

3. The apparatus of claim 1, wherein the plurality of water jet sprayers are arranged in multiple rows along the cleaner body, with each row containing 4-6 sprayers spaced at predetermined circumferential intervals.

4. The apparatus of claim 1, wherein each of the water jet sprayers includes a precision-drilled orifice of approximately 0.040-0.060 inches in diameter, and wherein the sprayers are oriented at compound angles comprising a radial angle of 15-30 degrees and a tangential angle of 30-45 degrees.

5. The apparatus of claim 1, wherein the cleaner body has an internal diameter of approximately 6-8 inches and a length of approximately 18-24 inches to accommodate standard roller brushes ranging from 4-inch trim rollers to 18-inch professional rollers.

6. The apparatus of claim 1, wherein the apparatus is configured to achieve 95% or greater paint removal efficiency in 6-12 minutes while consuming only 1.25-2.5 gallons of water per cleaning cycle.

7. The apparatus of claim 1, wherein the hose connector includes an internal flow restrictor to optimize water pressure within the manifold system for household water pressure operation.

8. The apparatus of claim 1, wherein the stabilizer comprises a low-friction bearing surface that permits the roller brush to rotate at 5-15 RPM under the influence of tangentially oriented water jets.

9. The apparatus of claim 1, further comprising a detergent injection system including a chemical reservoir and metering mechanism configured to introduce cleaning solutions into water supplied to the manifold.

10. The apparatus of claim 1, wherein the handle latch comprises a pivoting clamp mechanism with spring-loaded engagement designed to accommodate handle diameters ranging from 0.75 inches to 1.5 inches.

11. The apparatus of claim 2, wherein the wire strain is removable and replaceable, secured by one of a threaded collar, bayonet fitting, or snap-lock mechanism.

12. The apparatus of claim 1, further comprising at least one drainage port disposed at a lower portion of the cleaner body and coupled to a flexible discharge tube for directing wastewater away from the cleaning area.

13. The apparatus of claim 1, wherein the hose connector is alternatively replaceable with a manually pressurized water reservoir to provide cleaning fluid to the sprayers in locations where water line connections are unavailable.

14. The apparatus of claim 1, wherein the cleaner body is constructed from chemical-resistant materials selected from the group consisting of high-density polyethylene, polypropylene, fiberglass-reinforced composites, aluminum, and stainless steel.

15. The apparatus of claim 1, wherein the internal water manifold comprises a central distribution tube with multiple branch conduits designed to maintain approximately equal water pressure at each sprayer location.

16. A method for cleaning a paint roller brush, comprising the steps of:
securing a used paint roller brush within the apparatus of claim 1 using the stabilizer and handle retention system;
connecting a water source operating at household pressure to the hose connector;
directing water through the plurality of circumferentially arranged sprayers onto the roller nap for a predetermined cleaning duration of 6-12 minutes; and
terminating water flow and removing the cleaned roller brush from the apparatus;
wherein the method achieves 95% or greater paint removal efficiency while consuming approximately 75% less water than conventional cleaning methods.

17. The method of claim 16, further comprising inducing rotation of the roller brush at 5-15 RPM through the tangential orientation of the water jet sprayers to ensure uniform cleaning coverage of the entire roller surface.

18. The method of claim 16, further comprising:
introducing a cleaning solution selected from detergents, solvents, or paint thinners into the water stream during the cleaning cycle; and
following chemical cleaning with a clear water rinse cycle to remove residual chemicals and loosened paint debris.

19. The method of claim 16, wherein the cleaning duration is 6-8 minutes for latex paints and 8-12 minutes for oil-based paints, and wherein the method extends roller brush useful life from 3-5 uses to 15-20 uses.

20. The method of claim 16, wherein the predetermined cleaning duration and water pressure are selected to achieve optimal cleaning effectiveness while minimizing water consumption and preventing damage to the roller nap structure.
